(19) United States
(12) Patent Application Publication
(10) Pub. No.: US 2009/0193713 A1
(43) Pub. Date: Aug. 6, 2009

(54) Collapsible tree stand

(76) Inventors: Jamie Limber, Phoenix, AZ (US); Kristofer Halvorson, Phoenix, AZ (US); Brett Wilson, Phoenix, AZ (US)

Correspondence Address: The Halvorson Law Firm, Ste 130, 1757 E. Baseline Rd., Gilbert, AZ, 85233, US

(21) Appl. No.: 12/004,615

(22) Filed: Dec. 24, 2007

(51) Int. Cl. A47G 33/12; F16M 13/02

(52) U.S. Cl. 47/40.5; 248/529

(57) ABSTRACT

Disclosed is a tree stand that includes a flexible water reservoir as an integral part of the stand. The stand comprises a collar that is attached to first ends of a plurality of upper legs. The plurality of upper legs are attached at their second ends to first ends of a corresponding plurality of lower legs. The plurality of lower legs are attached at their second ends to a base section. Attached to an inner perimeter of the collar is the water reservoir. Located inside of the water reservoir, and attached to the base section, is a tree receiver.

### FIELD OF THE INVENTION

The present invention relates to tree stands. Specifically, the present invention relates to collapsible tree stands that utilize a closed, storage position and an open, tree-supporting position.

### BACKGROUND OF THE INVENTION

Christmas tree stands are a staple item in people's holiday decoration inventory. Because these stands are utilized with seasonal decorations they are normally utilized during a brief period of the year and generally spend the remainder of the year in storage. Moreover, most Christmas tree stands are large bowl shaped devices that require extraordinarily large storage containers, thereby occupying an inordinate amount of storage room, much of which is empty space. Consequently a collapsible tree stand would ensure the most efficient storage and utilization of space.

Various collapsible tree stands for vertically supporting a Christmas tree or artificial tree pole are known in the art. Many of these prior art stands require complete disassembly of the stand for storage while others utilize pivoting legs that fold into a position parallel to the tree axis. The vast majority of the collapsible tree stands in the prior art make no provision to watering a live tree.

Thus, the need exists for a rugged collapsible tree stand which provides for a simple set up and a stable Christmas tree that, when collapsed, occupies a small mount of storage space.

### SUMMARY OF THE INVENTION

It is therefore an object of this invention to provide a collapsible tree stand.

It is another object of the present invention to provide a collapsible tree stand that reduces the space required to store the collapsible tree stand.

It is yet another object of the present invention to provide a collapsible tree stand that provides a water reservoir for live tree use.

It is still yet another object of the present invention to provide a collapsible tree stand that includes a collapsible water reservoir.

It is a further object of the present invention to provide a tree stand with a large volume collapsible water reservoir.

It is yet a further object of the present invention to provide a tree stand with a water reservoir that is capable of holding over two gallons of water.

It is still yet a further object of the present invention to provide a tree stand with a collapsible reservoir that is capable of holding over two gallons of water, preferably over three gallons of water and most preferably, over four gallons of water.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWINGS

Other objects, features and advantages will occur to those skilled in the art from the following description of the preferred embodiment and the accompanying drawings, in which:

FIG. 1 is a perspective view of the tree stand in use according to the present invention.

FIG. 2A-F illustrates the tree stand from a closed configuration as it moves to an open configuration.

FIG. 3 shows the bottom view of the tree stand.

FIG. 4 shows the top view of the tree stand.

FIG. 5 is a perspective view of the present invention illustrating how the cup interacts with the collar.

FIGS. 6A and B are cut-away views of the present invention illustrating the cup locking mechanism in both the closed configuration (A) and the open and locked configuration (B).

FIG. 7 illustrates an alternate embodiment of the tree stand, showing a more cylindrical look.

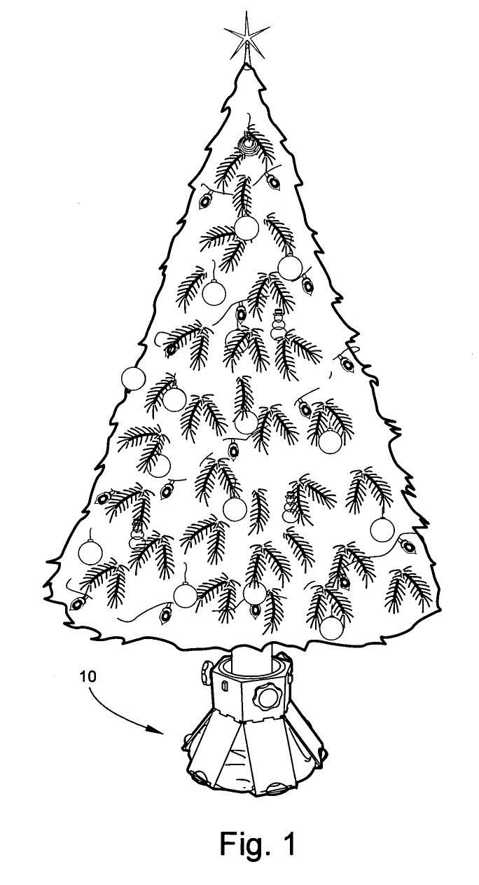

### DESCRIPTION OF THE PREFERRED EMBODIMENT

The present invention is a collapsible tree stand 10 that reduces the amount of space required to store the tree stand. The tree stand 10 according to the present invention is collapsible from an open, tree receiving configuration to a closed, storage configuration. In the open configuration the tree stand 10 is deployed, ready to receive a tree or other elongate object. In the closed configuration the tree stand is collapsed, thereby minimizing required storage volume of the stand 10.

The present invention is a stand 10 that comprises a collar section 20, a plurality of upper leg section 30 that pivotally attach at first ends 32 to the collar section 20. The plurality of legs 30 pivotally attach at their second ends 34 to first ends 42 of a corresponding plurality of lower legs sections 40. The plurality of lower legs 40 pivotally attach at second ends 44 to a base section 50. Attached to the collar 20 a flexible water reservoir 70. Attached through the water reservoir 70 and to the base section 50 is a tree receiver 60.

The preferred collar section 20 comprises a top surface 23 and bottom surface, an inner perimeter 22 and an outer perimeter 24. The top and bottom surfaces span the inner perimeter 22 and outer perimeter 24. Thus the inner perimeter 22 defines an interior aperture 21. While the overall shape of the collar 20 may vary from such shapes as a four sided square, through increasing numbers of sides to a circular shape, the preferred embodiment of the collar 20 comprises six sides, or a hexagonal shape. Other shapes for the collar 20 may be used and still fall within the scope of the present invention.

There are at least one, preferably six and more preferably three at least partially threaded apertures 26 for receiving tree securing bars 27. The threading may be completely helical, or there may be a single thread capable of allowing rotational movement of a threaded and received object such as a bolt or the like. At least one of the tree securing bars 27 is at least partially threaded along a portion of the length of the bar. More that one of the tree securing bars 27 may be partially threaded, up to and including all of the tree securing bars 27. Attached to an inwardly directed end of at least one of the tree securing bar 27 may be a tree support brace and attached to the outwardly directed end of the at least one tree securing bar 27 is a handle 29. The handle 29 may be a handle 29 of various shapes such as J-shaped, C-shaped, circular shaped, star shaped or the like; or it may be an inset shape such a utilized in star or hex drives. More than one of the tree securing bars 27 may include support braces and more than on of the tree securing bars 27 may include handles 29.

The upper legs 30 and lower legs 40 are preferably thin sections with a generally square or rectangular outline that are preferably flat or slightly curved, but other shapes may be used. Both upper legs 30 and lower legs 40 require first and second ends 32, 34 and 42, 44 respectively. The first ends 32 of the upper legs 30 are pivotally attached to the collar section 20. The location of the pivotal attachment is at or adjacent the join of the outer perimeter 24 and the bottom surface. The second ends 34 of the upper legs 30 are pivotally attached to first ends 42 of the lower legs 40. The second ends 44 of the lower legs 40 are pivotally attached to a base section 50. This forms an elongate package generally of the configuration of the collar 20, followed by upper legs 30 followed by lower legs 40 followed by base section 50. This puts the base section 50 at a location distal to the collar 20.

The pivotal attachment mechanism between the plurality of first ends 32 of the upper legs 30 to the collar section 20; the plurality of second ends 34 of the upper legs 30 and the plurality of first ends 42 of the lower legs 40; and the plurality of second ends 44 of the plurality of the lower legs 40 and the base section 50 may be rigid, as in a traditional hinge system, but may preferably flexible, as in what is commonly known as a ‘living hinge’. Thus, the pivotal attachment may be by any number of different mechanisms that are known in the arts, such as living hinges, piano hinges, pin and barrel hinges and the like.

Attached to the lower legs 40, adjacent to the first ends 42 are a corresponding plurality of foot pads 45. The foot pads 45 may be of any shape, but are preferably disk shaped. Accordingly, since the foot pads 45 are located adjacent to the first ends 42 of the lower legs 40, a portion of the foot pads 45 may extend beyond the first ends 42. There also may be an upper, shaped cut-out 36 located at the second ends 34 of the upper legs 30 that receives the extending portion of the foot pads 45. The foot pads 45 may be removably attached, but are preferably permanently attached. Alternatively, the foot pads may be integrally molded into the first ends 42 of the lower legs 40.

Additionally, located at the second ends 44 of each of the lower leg 40 is a stability ridge 48. The stability ridge 48 lowers the center of gravity of the tree stand 10 when it is in a collapsed configuration, thereby making it more stable and less prone to tip-over.

There is a flexible water reservoir 70 that is attached to the collar 20 and the base section 50. The water reservoir 70, which may have either an open container configuration or a closed container configuration, is capable of holding over two gallons of water, preferably over three gallons of water and most preferably, over four gallons of water. Preferred flexible water reservoirs 70 may be made from plastics, polymers, rubbers, coated cloths or any other such flexible, water impermeable materials. The water reservoirs 70 may be injection molded, blow molded, sewn, folded and/or chemical/heat welded or otherwise formed into a water containing enclosure. The preferred water reservoir, according to the present invention, includes a series of pre-folds that allows the water reservoir 70 to fold into a space saving configuration that is contained within the tree stand 10 when the tree stand is in its closed configuration. In it preferred form, the water reservoir 70 is located within the volume defined by the leg sections, 30 and 40, respectively, but an alternate embodiment contemplates the water reservoir 70 containing the leg sections and their enclosed volume.

There is a tree receiver 60 that is located inside of the water reservoir 70. The preferable form of tree receiver 60 is a cylindrical cup 62 that attaches to the inner perimeter 22. The cylindrical cup 62 may be capable of holding water, but the cylindrical cup 62 may be perforated and not capable of holding water. The tree receiver 60 may have other shapes and still fall within the scope of the present invention. Preferably the tree receiver 60 is attached to the bottom section 50 with or through the water reservoir 70.

Preferably, the tree receiver 60 has locking tangs 55 located near the top of the receiver 60 for locking the stand into an open position. The inner perimeter 22 of the collar 20 further may include tang channels 56 that guide the tangs 55 into a locking position where a nib located on an outward facing side of each tang 55 is received by a depression located at the top of each tang channel 56, thereby “locking” the stand 10 into an open configuration. Movable buttons 52 are included in the collar 20 in order to eject the nibs of the tangs 55 from the depression, thereby allowing the tangs 55 to slide down the channels 56 to their unlocked position. These buttons 52 may include a biasing mechanism 53, such as a spring or the like. Located neat the top 51 of the tree receiver 60 may be securing bar cut outs 58, sized and shaped to receive the tree receiving bars 27 when the stand 10 is in the open configuration.

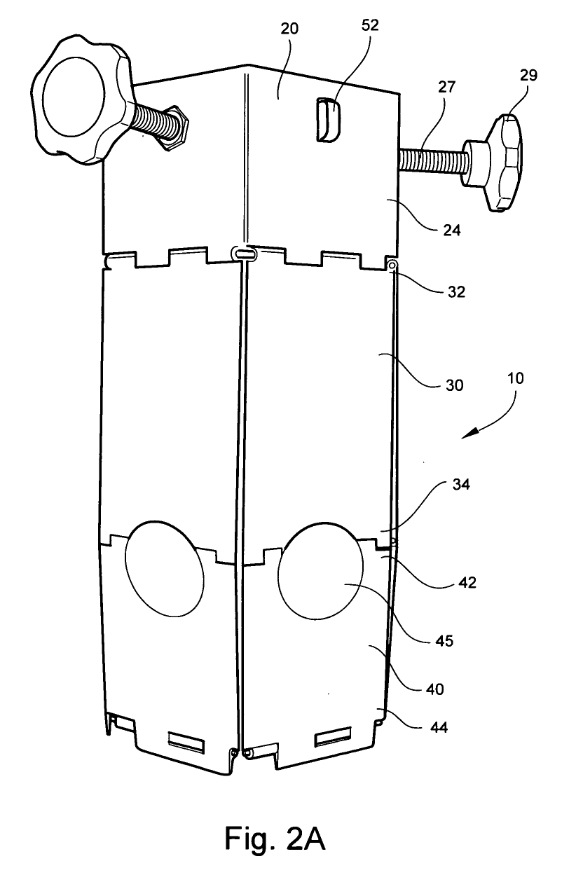

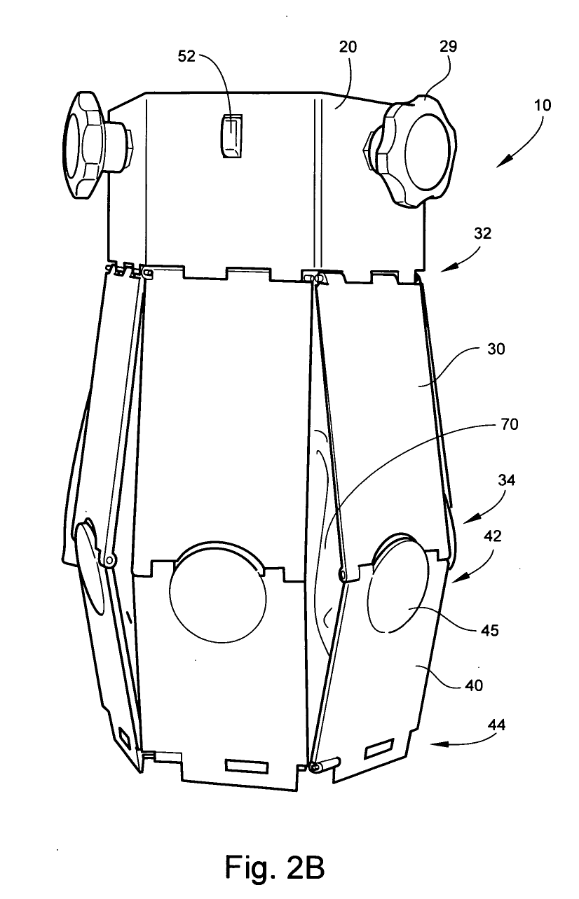

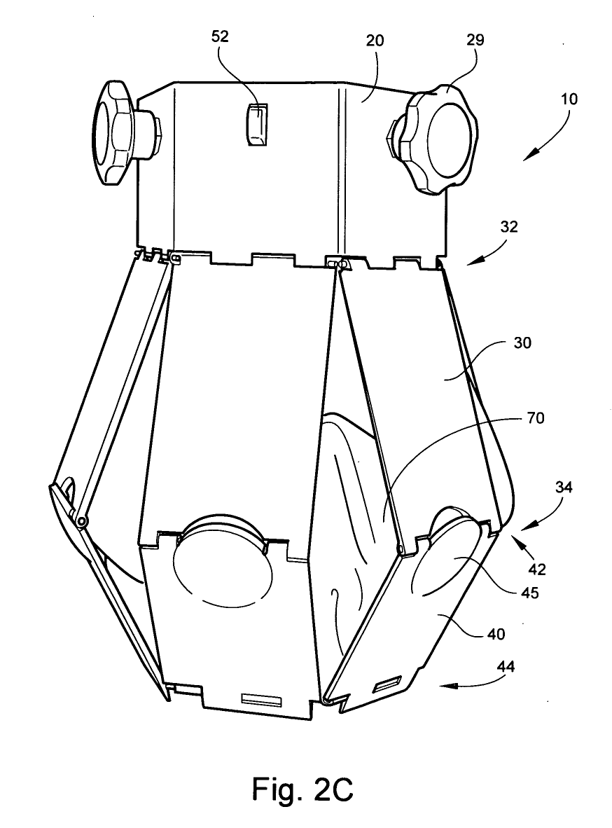

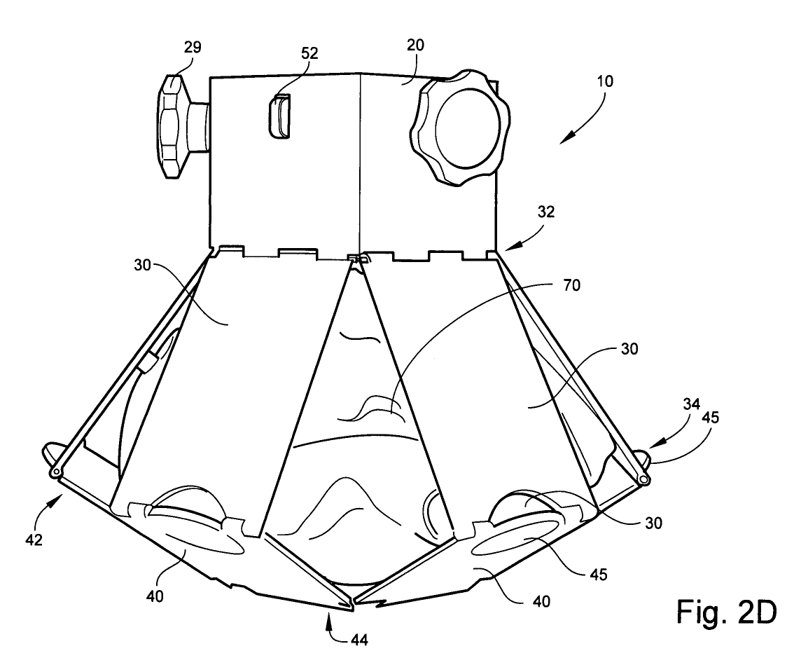

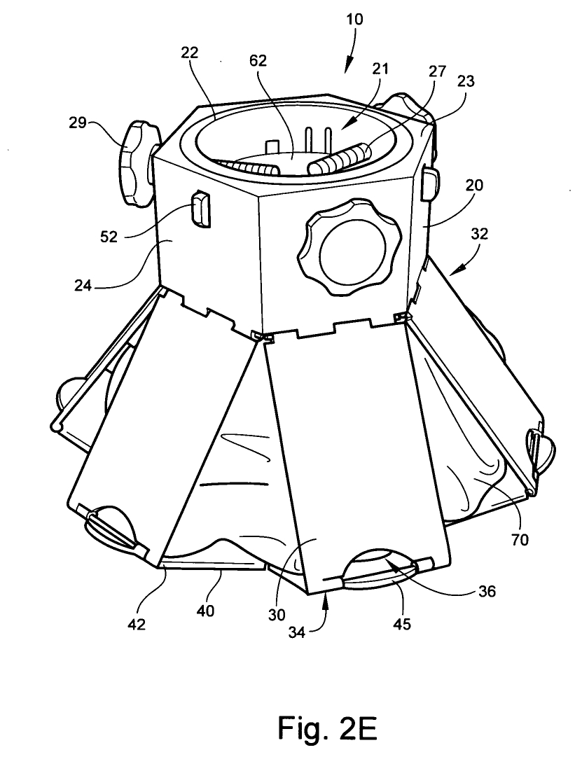

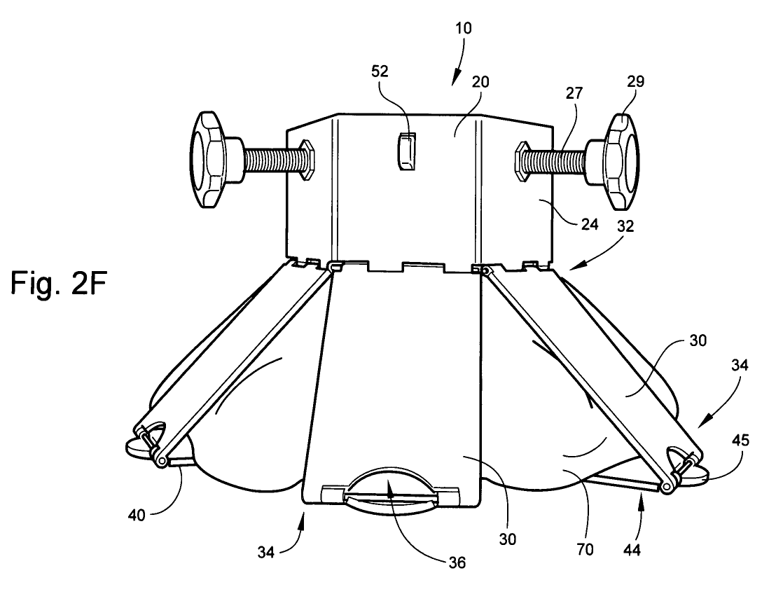

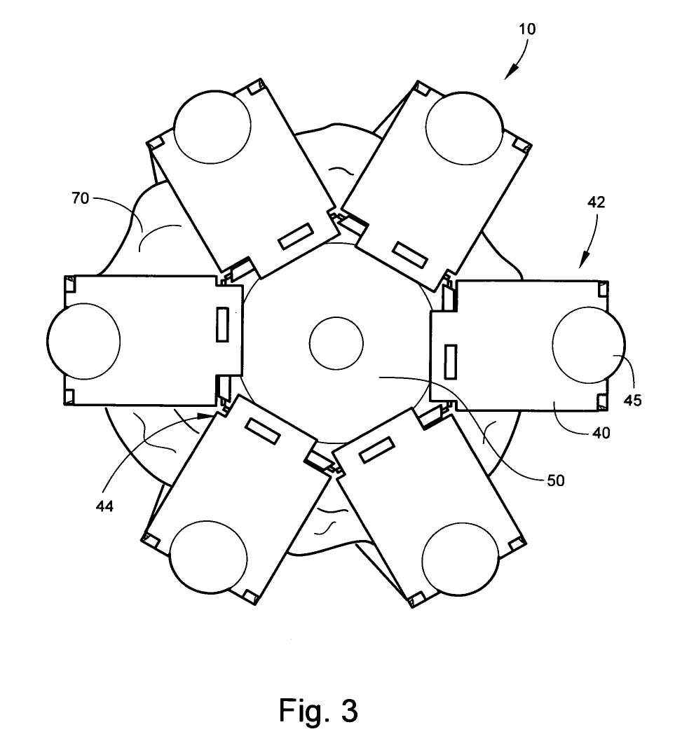

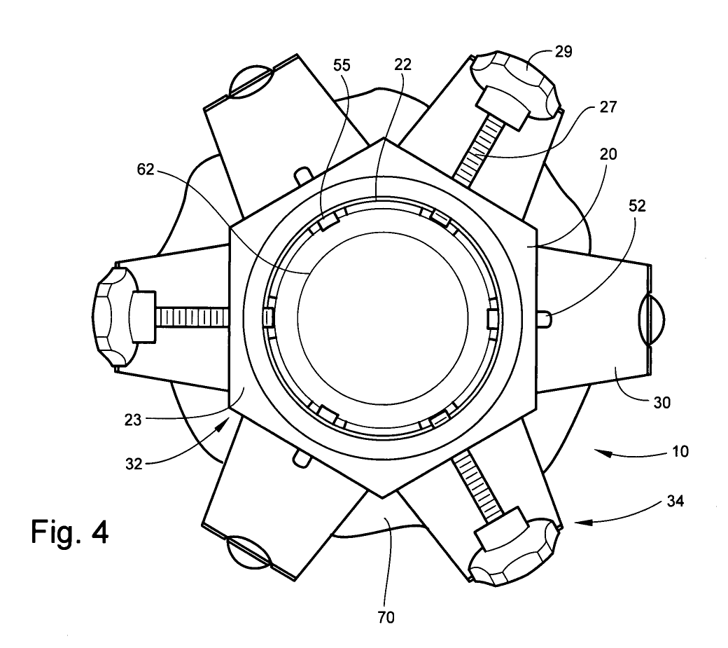

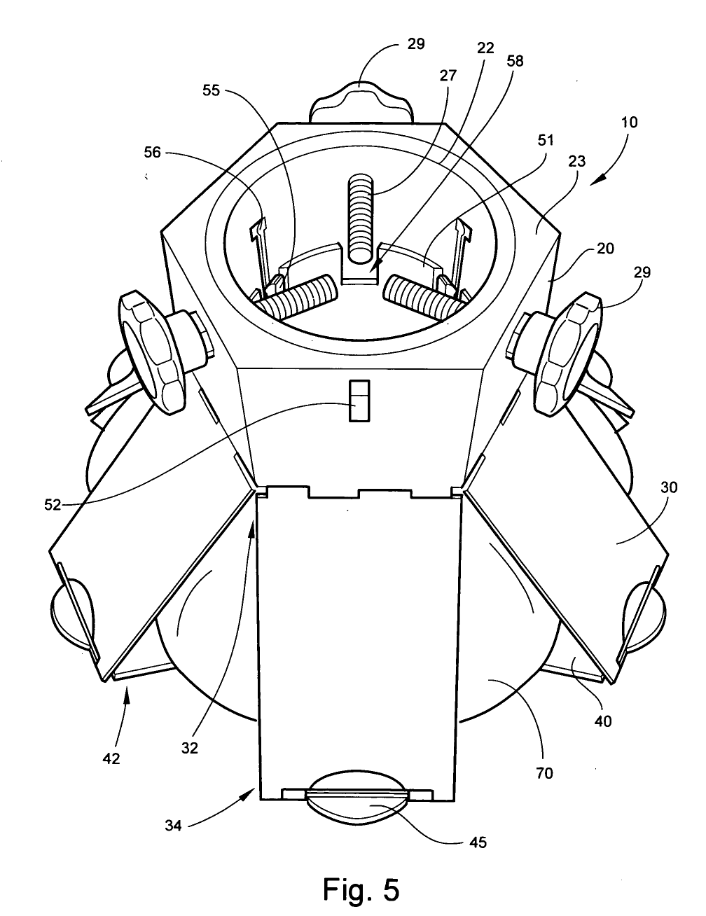

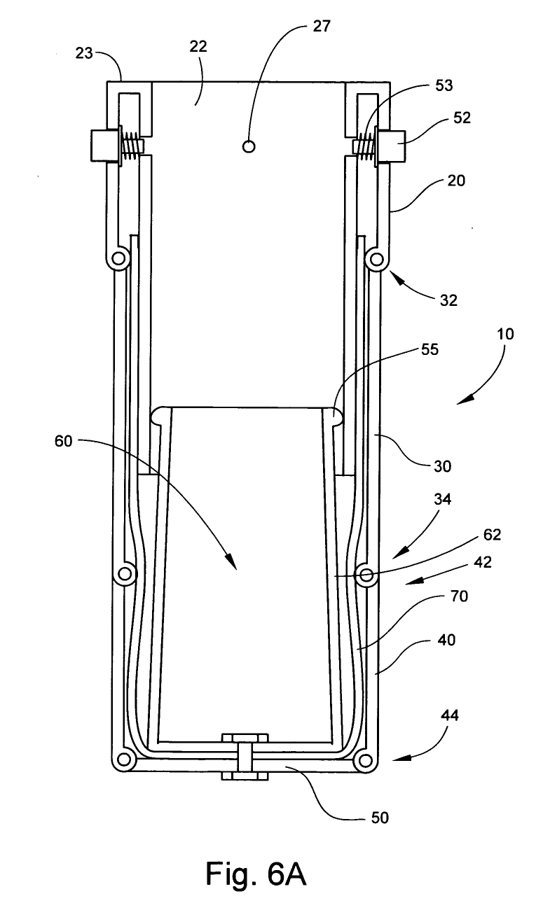

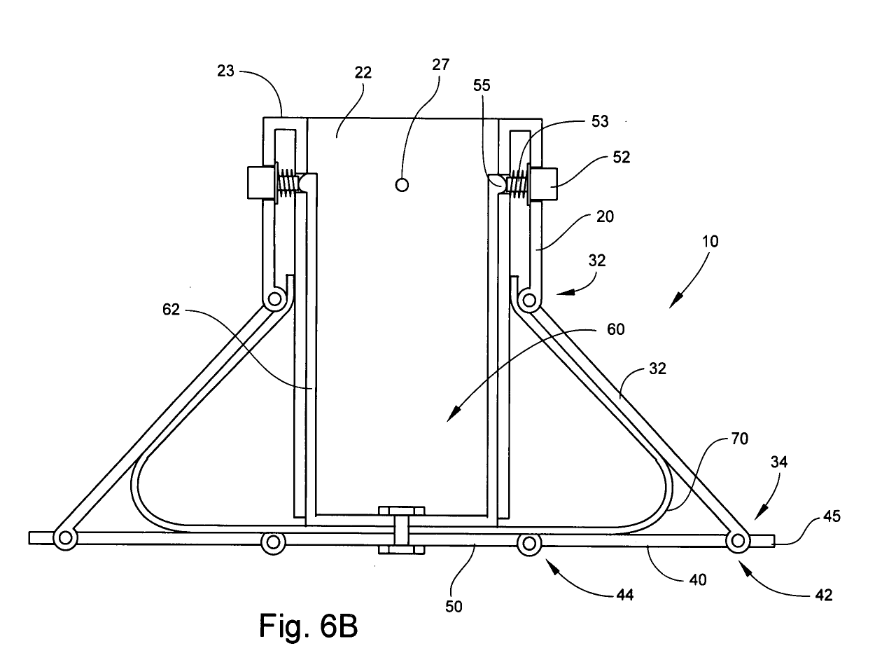

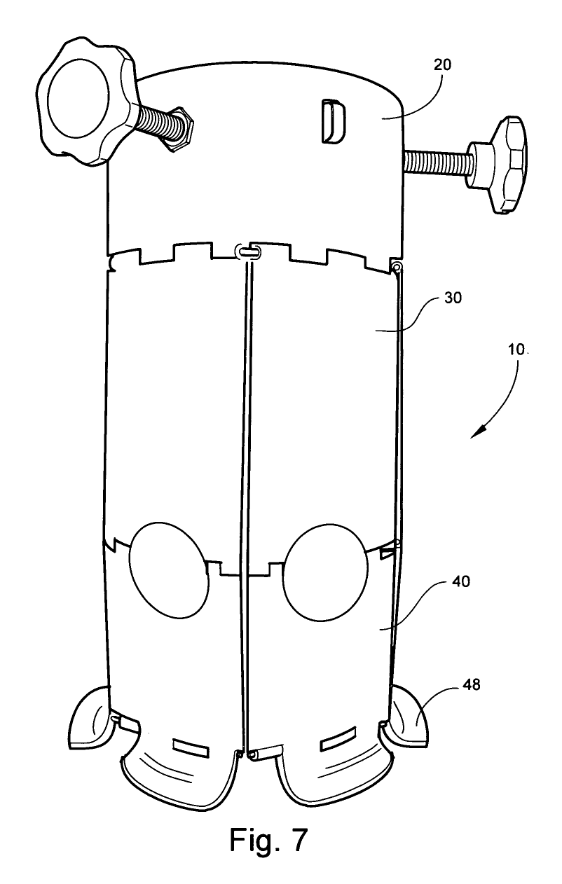

In use, the tree stand 10 starts in a closed position. See FIG. 2A. A gentle pressure is applied to the collar 20 of the stand 10 forcing the second end 34 of the upper leg section 30 and first end 42 of the lower leg sections 40 to move radially away from the axis of the tree stand 10. This gradually forces the bottom section 50 and attached bottom of the water reservoir 70 and tree receiver 60 to move toward the collar 20, thereby sliding the tangs 55 upward in the tang channels 56. See FIGS. 2B to 2E. Once collar 20 has been pushed toward the bottom section 50 enough for the tang nib to enter the depression in the tang channel 56, the stand 10 locks into the open position with the lower legs 40 being in a generally perpendicular orientation relative to the axis of the stand 10. See FIG. 2F

In this position the trunk of a tree may be inserted into the aperture of the collar 20 and into the tree receiver 60. The securing bars 27 are rotated by the handles 29 until the ends of the securing bars, or if equipped, the tree braces, are in tight, secure, contact with the tree. Water may then be poured into the flexible water reservoir 70 until full. The benefit of having such a large flexible water reservoir is that trees typically use about one gallon of water per week and a four to five gallon water reservoir 70 would eliminate the need to rewater the tree for at least a month or more.

To collapse the tree stand 10, the tree is removed, any residual water is removed and buttons 52 are depressed, thereby forcing the nibs of the tangs 55 out of the locking depression. The bottom 50 may be drawn away from the collar 20, thereby forcing the second ends 34 of the upper legs 30 and the first end 42 of the lower legs 40 back into co-alignment with the axis of the stand 10. This is just a reverse of the procedure to open the stand 10.

In an alternate embodiment of the stand 10 according to the present invention, the lower legs 40 may be folded into a position interior parallel to the upper legs 30 and on the inside of the stand 10 with the base section 50 located close to the collar 20.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated. Other embodiments will occur to those skilled in the art and are within the following claims:

What is claimed is:

1. A tree stand comprising a tree receivable stand and an internally attached flexible water reservoir.

2. The tree stand according to claim 1 wherein the internal flexible water reservoir is capable of holder over two gallons of water.

3. The tree stand according to claim 1 wherein the internal flexible water reservoir further comprises a series of pre-folds.

4. The tree stand according to claim 2 wherein the internal flexible water reservoir further comprises a series of pre-folds.

5. The tree stand according to claim 1 wherein the stand further comprises a series of legs and the flexible water reservoir is located within the volume spanned by the series of legs.

6. The tree stand according to claim 1 wherein the stand further comprises a series of legs and the flexible water reservoir contains leg sections and the volume spanned by the series of legs.

7. A tree stand comprising a collar section pivotally attached to first ends of a plurality of upper leg sections, the plurality of upper leg sections are pivotally attached at second ends to first ends of a corresponding plurality of lower leg sections, the plurality of lower leg sections are pivotally attached at their second ends to a base section, spanning the collar and base section is a flexible water reservoir.

8. The tree stand according to claim 7 wherein said flexible water reservoir is located within the volume spanned by the leg sections.

9. The tree stand according to claim 7 wherein said flexible water reservoir contains leg sections and the volume spanned by the leg sections.
